(19) United States
(12) Patent Application Publication
(10) Pub. No.: US 2023/0202561 A1
(43) Pub. Date: Jun. 29, 2023

(54) INDEPENDENT WHEEL SHIFTABLE WHEEL DRIVES

(71) Applicant: Wrightspeed, Inc., Alameda, CA (US)

(72) Inventors: Edward Alan Dowdell, Saratoga, CA (US); Andrew Schini, Oakland, CA (US); Christopher Straith McIntosh, Orinda, CA (US); Ian Sowden, San Francisco, CA (US)

(73) Assignee: Wrightspeed, Inc., Alameda, CA (US)

(21) Appl. No.: 17/646,407

(22) Filed: Dec. 29, 2021

(51) Int. Cl. B62D 11/04; B60K 1/02; B60K 17/02; F16H 59/44; F16H 61/70; B60K 17/06; F16H 59/70; B62D 12/00; B60K 17/356; F16H 59/36; F16H 57/02

(52) U.S. Cl. CPC B62D 11/04; B60K 1/02; B60K 17/02; F16H 59/44; F16H 61/702; B60K 17/06; F16H 59/70; B62D 12/00; B60K 17/356; F16H 2059/366; F16H 2057/02034; F16H 2200/0021; F16H 2057/02052

(57) ABSTRACT

Described herein are systems and techniques for utilizing a powered axle that includes a plurality of transmissions. The powered axle may include separate transmissions to power wheels on opposite ends of the powered axle. Each transmission of the powered axle may be operated independently of the other transmission. As such, the plurality of transmissions of the powered axle may be shifted independently of each other. Various control schemes may be provided for operation of such transmissions.

### BACKGROUND

Electrical vehicles are set to replace internal combustion vehicles, even for industrial applications such as buses, delivery trucks, and the like. Electrical vehicles, including the ones equipped with range extenders, produce less pollution and noise and tend to be more cost-effective to operate. Typically, one electrical motor is used for axle and the electrical assist is single speed. Even vehicles that include a gearbox with the electrical motor utilize a single motor for each axle. However, industrial vehicles have large form factors, are cumbersome to maneuver, and are generally sensitive to environmental conditions such as road grade, wind, and payload. Furthermore, certain types of industrial vehicles place a large premium on smoothness of operation.

### SUMMARY

Provided are industrial electrical vehicles and methods of operating thereof. In a certain embodiment, a vehicle axle may be disclosed. The vehicle axle may include an axle housing, the axle housing including a first output end and a second output end, a first powertrain, coupled to the axle housing and including a first electric motor, configured to generate first input torque and a first transmission, including a first plurality of selectable speeds, each of the first plurality of selectable speeds configured to receive the first input torque and provide mechanical modification of the first input torque to output first output torque to the first output end, and a second powertrain, coupled to the axle housing and including a second electric motor, configured to generate second input torque and a second transmission, including a second plurality of selectable speeds, each of the second plurality of selectable speeds configured to receive the second input torque and provide mechanical modification of the second input torque to output second output torque to the second output end.

In another embodiment, a vehicle dynamics control system may be disclosed. The vehicle dynamics control system may include a first powertrain, coupled to a first wheel and including a first electric motor and a first transmission, coupled to the first electric motor and comprising a first plurality of selectable speeds, a second powertrain, coupled to a second wheel and including a second electric motor and a second transmission, coupled to the second electric motor and including a second plurality of selectable speeds, and a main control processor, configured to perform operations including receiving vehicle speed and direction data from at least one sensor, receiving driver data from at least one driver input sensor, determining, based on the driver data and the vehicle speed and direction data, a first required output torque for the first wheel and a second required output torque for the second wheel, selecting, based on the first required output torque, a first selected speed from the first plurality of selectable speeds of the first transmission, and selecting, based on the second required output torque, a second selected speed from the second plurality of selectable speeds of the second transmission.

In a further embodiment, an electrical vehicle may be disclosed. The electric vehicle may include a first wheel, a second wheel, a first vehicle axle, a second vehicle axle, and a controller. The first vehicle axle may include a first gearbox, configured to switch between multiple first gears and comprising a first input shaft and a first output shaft, where the first output shaft is mechanically coupled to the first wheel, a second gearbox, configured to switch between multiple second gears and comprising a second input shaft and a second output shaft, where the second output shaft is mechanically coupled to the second wheel, a first electric motor, mechanically coupled to the first input shaft of the first gearbox, and a second electric motor, mechanically coupled to the second input shaft of the second gearbox. The controller may be communicatively coupled to each of the first gearbox, the second gearbox, the first electric motor, and the second electric motor, where the controller is configured to instruct the first gearbox to switch between the multiple first gears and, independently, to instruct the second gearbox to switch between the multiple second gears.

These and other embodiments are described further below with reference to the figures.

### BRIEF DESCRIPTION OF THE DRAWINGS

FIG. 1 illustrates an industrial vehicle, in accordance with some embodiments.

FIGS. 2A-D illustrate representations of powered axles for industrial vehicles, in accordance with some embodiments.

FIG. 3 illustrates a block diagram of an industrial vehicle powertrain system and control systems for operation thereof, in accordance with some embodiments.

FIGS. 4A-D illustrate representations of powered axle configurations for industrial vehicles, in accordance with some embodiments.

FIG. 5 illustrates a perspective view of an embodiment of a transmission for a powered axle, in accordance with some embodiments.

FIG. 6 illustrates a flowchart illustrating a method of operating a powered axle, in accordance with some embodiments.

FIG. 7 illustrates a flowchart illustrating a method of operating a trailer with a powered axle, in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

For purposes of this disclosure, an electrical vehicle is defined as any vehicle using one or more electrical motors to drive one or more wheels of the vehicle. For example, an electrical vehicle may include one electrical motor for each wheel, one electrical motor for an axle (using a differential), or even one motor for multiple axles (using multiple differentials). An electrical motor uses electrical power to drive the one or more wheels by applying the torque to the wheels and may generate electrical power when the torque is applied by the wheels (e.g., for regenerative braking). As such, the electrical motor may be also referred to as an electrical drive motor-generator.

The electrical vehicle may or may not include electrical range extenders. Electrical range extenders are used to increase vehicle driving ranges (beyond the battery capacity) and to allow using smaller batteries thereby lowering vehicle cost and, in some instances, lowering vehicle weight. During its use, the electrical range extender generates electrical power which may be directed to a battery (for recharging) and/or to electrical drive motor-generator. The electrical power is generated by rotating an electrical generator using some form of a drive, such as a turbine, piston-engine, or the like. Electrical range extenders should not be confused with non-electrical drives supplying mechanical power to the wheels. These non-electrical drives bypass electrical drive motor-generators and do not generate electrical power. For example, a piston-engine may be connected to a vehicle transmission together with an electrical drive motor-generator.

Drives used in electrical range extenders may be operated in more efficient regimes than, for example, when these drives are used directly to drive the wheels. For example, piston-based internal combustion engines (ICEs) used on conventional non-electrical vehicles have low efficiencies during acceleration and other operating conditions. When a piston-based ICE is used as a range extender, efficiency of this ICE may be substantially improved.

Industrial vehicles typically include beam axles that support wheels on opposite sides of the vehicle (e.g., on the left and right sides of the vehicle). The beam axle may be suspended through various types of suspension and may, in certain embodiments, be powered (e.g., may be a live axle). In certain embodiments described herein, such live axles may be powered by one or more electrical motors. The electrical motors may be coupled to transmissions or transaxles that include a plurality of speeds to allow for different amounts of torque multiplication. Furthermore, the different speeds allow for operation of the electrical motors at different rpms. Each transmission or transaxle may be associated with the wheels on one side of the vehicle and may be independently shifted. Thus, for example, the plurality of transmissions or transaxles for each axle may be in different gears that includes different gearing multiplication. Thus, the wheel(s) on each side of the axle may be provided with different torque multiplication, allowing for adjustments in handling characteristics, vehicle behavior, or for smooth shifting of the vehicle. Though the disclosure herein may generally prefer to powered axles, it is appreciated that the systems and techniques described herein may additionally apply to non-beam axle configurations. Thus, for example, independent suspensions on opposite sides of a vehicle may also include their own electrical motors that are operated with independent transmissions. Such configurations may also utilize the operational techniques described herein.

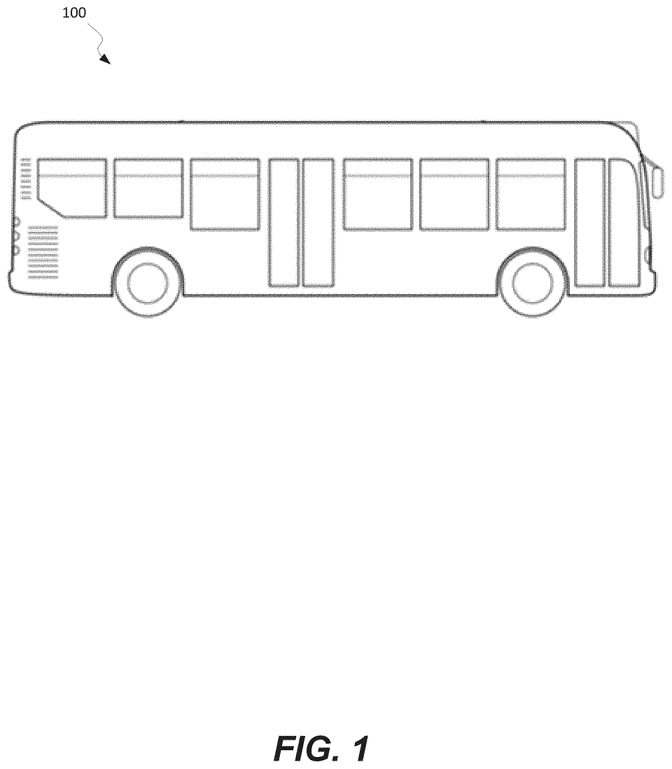

The systems and techniques for powered axles that include a plurality of transmissions and/or transaxles may be utilized in industrial vehicles, as well as other vehicle applications, such as passenger vehicles, military vehicles, racing vehicles, and other such vehicles. The powered axles may be provided as original equipment or may be retrofitted to such vehicles. FIG. 1 illustrates an industrial vehicle, in accordance with some embodiments. Specifically, industrial electrical vehicle 100 may include one or more batteries, range extenders, electrical motors, and various power consuming devices, as well as a plurality of transmissions and/or transaxles for at least one electrically powered axle.

In various embodiments, the range extender receives fuel from a fuel tank and generates electrical energy, when operating. This generated electrical energy is supplied to the battery for storage. The electrical motor then receives electrical energy from the battery to propel industrial electrical vehicle 100, e.g., to generate mechanical energy applied to wheels. The mechanical energy may be applied to the wheels through one or more transmissions or transaxles. The electrical motor is also configured to operate in a regenerative mode to slowdown industrial electrical vehicle 100. In this regenerative mode, mechanical energy is applied by the wheels to the electrical motor. The electrical motor converts this mechanical energy into electrical energy and supplies the electrical energy to the battery. In some examples, the regenerative mode may not be sufficient to slowdown industrial electrical vehicle 100, at which point some mechanical energy is transferred to the friction brakes, which convert the mechanical energy into heat and dissipates this heat into the environment.

The power consuming devices may include air-conditioner, heater, lights, and the like. The power consuming devices receive electrical energy from the battery for various requested operations of the devices. The battery is also configured to receive electrical energy from an external charging station, e.g., when industrial electrical vehicle 100 is parked near and plugged into a power plug of the external charging station. It should be noted that industrial electrical vehicle 100 can include various other components, such as inverters, power converters, and such.

Powered Axle with Gearbox Examples

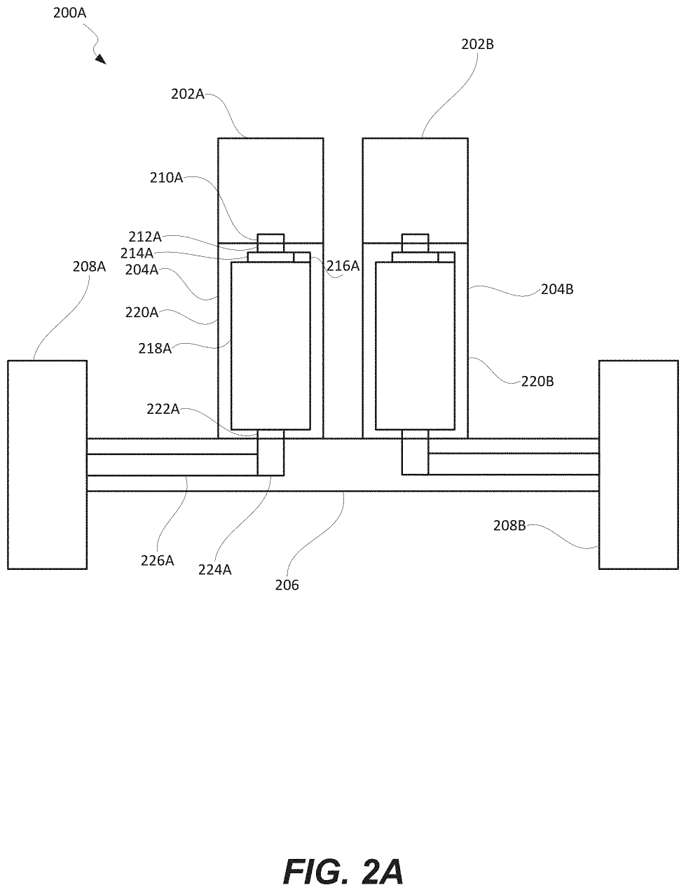

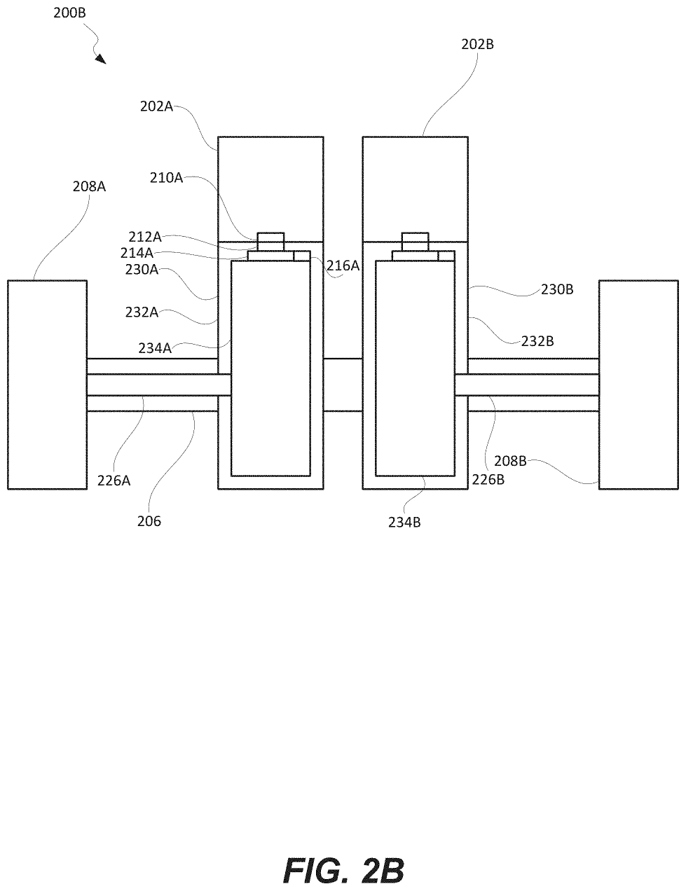

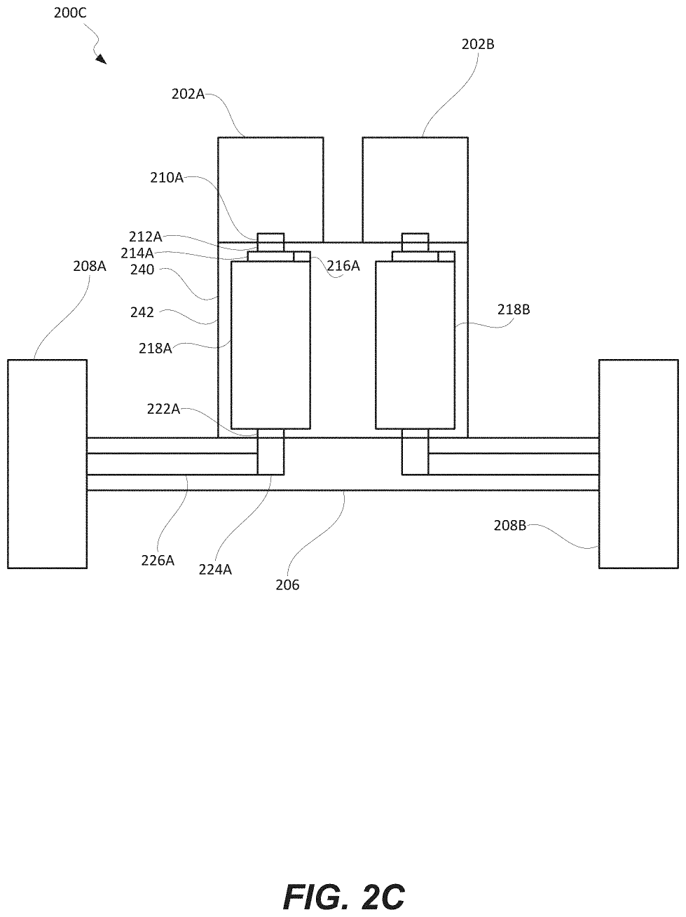

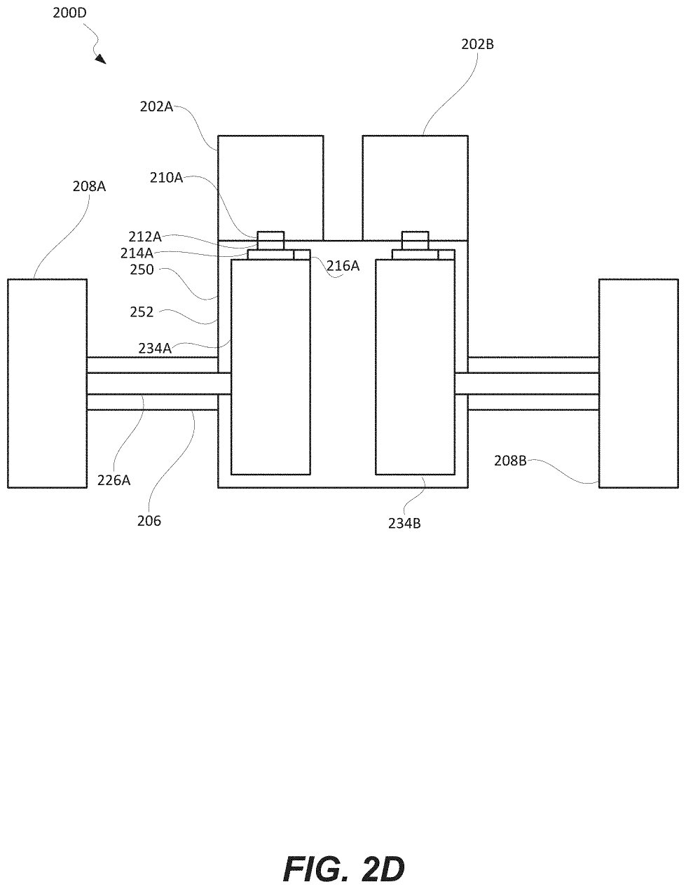

In various embodiments described herein, a powered axle may include one or more transmissions with separate gearsets for different wheels (e.g., wheels on opposite sides of the axle). FIGS. 2A-D illustrate representations of powered axles for industrial vehicles, in accordance with some embodiments. Such powered axles may be equipped with an industrial electrical vehicle and/or may be utilized as an axle to be retrofitted to existing industrial electrical vehicles.

FIG. 2A illustrates powered axle 200A that includes electrical motors 202A and 202B. Electrical motors 202A and 202B are coupled to transmissions 204A and 204B, respectively. Transmissions 204A and 204B are each coupled to axle 206. Wheels 208A and 208B are coupled to respective left and right ends of axle 206. Transmission 204A may be configured to provide gear multiplication for electrical motor 202A to power wheel 208A. Transmission 204B may be configured to provide gear multiplication for electrical motor 202B to power wheel 208B. Thus, the wheels on either side of axle 206 may receive power with gear multiplication through an individual gearbox per side. In such embodiments, each of transmissions 204A and 204B may be coupled to the respective wheels 208A and 208B via gearing 224A and 224B and halfshafts 226A and 226B. For the purposes of simplicity, it is appreciated that, in the embodiments described herein, though only one side of powered axles may be described by ordinal indicators (e.g., for gearing 224A and halfshaft 226A), the equivalent other side may also include corresponding such components and corresponding ordinal indicators (e.g., for gearing 224B and halfshaft 226B, the ordinal indicators of which are not shown).

Accordingly, description may be provided to one side of powered axle 200A, but such description may also apply to the other side. Electrical motor 202A may be electrical motors that generate power that may be provided to transmission 204A via motor output 210A. Electrical motor 202A may include any motor design that receives electrical power and outputs rotational torque from the electrical power.

Motor output 210A may be a shaft, flywheel, and/or other such component that may be configured to couple with transmission input 212A. Transmission input 212A may be an equivalent such shaft, flywheel, opening, and/or other such component configured to interface with motor output 210A. Thus, electrical motor 202A, may be configured to generate first input torque (e.g., rotational torque generated by electrical motor 202A). Transmission input 212A may be configured to receive such input torque generated by electrical motor 202A.

Clutch 214A may be coupled to transmission input 212A, before or after transmission input 212A (e.g., either between motor output 210A and transmission input 212A or between transmission input 212A and gearset 218A). Clutch 214A may allow for coupling and decoupling of gearset 218A relative to electrical motor 202A. In various embodiments, clutch 214A may be a plate clutch, a dog clutch, a multi-plate clutch, and/or another such device that allows for mechanical coupling and decoupling between gearset 218A and electrical motor 202A.

In certain embodiments, clutch 214A may be a dog clutch. Though dog clutches are robust, they typically engage with a high level of noise and vibration. The lack of smoothness for dog clutches renders them unsuitable for applications for carrying passengers. In certain embodiments, powered axle 200A includes clutch speed sensor 216A. Clutch speed sensor 216A may sense a rotational speed of clutch 214A and may provide data directed to such rotational speeds to a controller of the vehicle, such as a controller described herein. The controller may then cause electrical motor 202A to operate at a rotational speed matching that of the rotational speed of clutch 214A. As such, clutch 214A may more smoothly mechanically couple motor 202A to gearset 218A.

Gearset 218A may include a plurality of gears or sets of gears to offer a plurality of selectable speeds for transmission 204A. In certain embodiments, the various speeds of gearset 218A may offer different gear multiplication. As such, the maximum speed and the torque multiplication of each speed, or at least two different speeds, may be different, allowing for electrical motor 202A to operate within different portions of its powerband and for wheel 208A to provide different levels of effective wheel torque while operating at the same motor speed. In certain embodiments, 218A may include any type of appropriate gearset.

Gearset 218A is coupled to gearing 224A, which may be a bevel gear or another mechanical coupling that allows for torque output by gearset 218A to change direction. Gearing 224A is coupled to halfshaft 226A, which is coupled to wheel 228A. Halfshaft 226A may transfer torque from gearing 224A to wheel 228A, to rotate wheel 228A and, thus, power wheel 228A to dynamically move the vehicle that powered axle 200A is coupled to.

In the embodiment of FIG. 2A, transmission 204A and 204B includes separate transmission casings 220A and 200B, respectively. As such, transmissions 204A and 204B are separate from each other. Various other configurations are shown in FIGS. 2B-D. It is appreciated that, for the purposes of brevity, certain components are similar between the various embodiments of FIGS. 2A-D, such as electrical motors 202A and 202B, and are thus not repeatedly described.

For example, FIG. 2B illustrates an embodiment of powered axle 200B that includes transaxles 230A and 230B. Transaxles 230A and 230B may be transaxles that include gearsets 234A and 234B. Gearset 234A is coupled to and configured to receive torque from electrical motor 202A, provide torque multiplication via one of a plurality of shiftable gears, and output torque to halfshaft 226A. Similarly, gearset 234B is coupled to and configured to receive torque from electrical motor 202B, provide torque multiplication via one of a plurality of shiftable gears, and output torque to halfshaft 226B. Thus, transaxles 230A and 230B are configured to receive torque from electrical motors 202A and 202B, respectively, as input in one direction and output torque to halfshafts 226A and 226B in another direction. As such, powered axle 200B does not include gearing 224A and 224B due to transaxles 230A and 230B. In the embodiment of powered axle 200B, transaxles 230A and 230B each include separate transaxle casings 232A and 232B.

FIG. 2C illustrates powered axle 200C that includes transmission 240 with a plurality of gearsets 218A and 218B disposed within a single transmission casing 242. Gearset 218A is coupled to and configured to receive torque from electrical motor 202A and output torque to gearing 224A and halfshaft 226A while gearset 218B is coupled to and configured to receive torque from electrical motor 202B and output torque to gearing 224B and halfshaft 226B. Disposing gearsets 218A and 218B within a single transmission casing 242 may decrease complexity and increase powertrain rigidity. In various embodiments, transmission casing 242 may, for example, include features configured to receive electrical motors 202A and 202B as well as axle 206.

Similarly, FIG. 2D illustrates powered axle 200D that includes transaxle 250 that includes gearsets 234A and 234B disposed within a single transaxle casing 252. Similar to FIG. 2B, gearset 234A is coupled to and configured to receive torque from electrical motor 202A, provide torque multiplication via one of a plurality of shiftable gears, and output torque to halfshaft 226A while gearset 234B is coupled to and configured to receive torque from electrical motor 202B, provide torque multiplication via one of a plurality of shiftable gears, and output torque to halfshaft 226B. Furthermore, similar to the single casing configuration of FIG. 2C, disposing gearsets 234A and 234B within a single transaxle casing 252 may decrease complexity and increase powertrain rigidity.

### Industrial Electrical Vehicle Examples

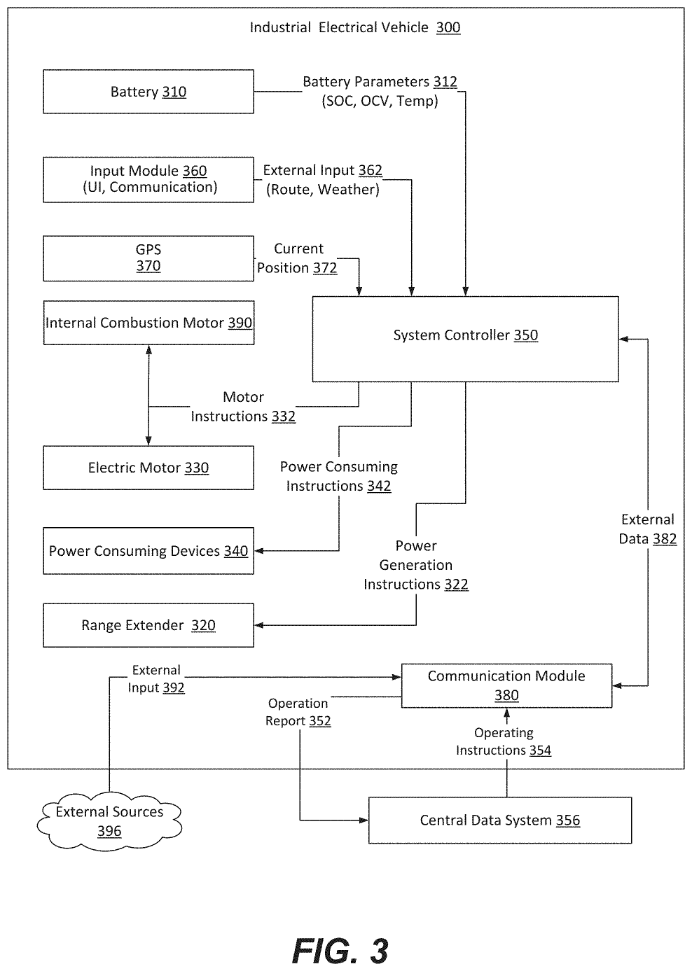

FIG. 3 illustrates a block diagram of an industrial vehicle powertrain system and control systems for operation thereof, in accordance with some embodiments. FIG. 3 illustrates industrial electrical vehicle 300. Industrial electrical vehicle 300 includes battery 310, input module 360, global positioning system (GPS) 370, internal combustion motor 390, electric motor 330, power consuming devices 340, range extender 320, communication module 380, and system controller 350.

System controller 350 may receive data from various other systems of industrial electrical vehicle 300 and provide instructions for operation of one or more systems of industrial electrical vehicle 300. Such data may be received and/or provided in any appropriate format, such as CANBUS and other formats utilized for vehicle control. System controller 350 may include any combination of processors, memories, accelerators, software, firmware, and/or other such components to implement the operations described herein and cause system controller 350 to receive data and provide data to the various systems described herein. Furthermore, the data connections described herein may include any specification of connectors to provide for wired and/or wireless communication of data.

Battery 310 may be configured to store electrical energy and provide such energy to power electric motor 330, power consuming devices 340, GPS 370, communication module 380, input module 360, and/or other systems of industrial electrical vehicle 300. Battery 310 may provide battery parameters 312 to system controller 350. Battery parameters 312 may include parameters such as state of charge, open-circuit voltage, battery temperature, and/or other such parameters.

Input module 360 may be a component configured to receive inputs from external sources, such as an external data source (e.g., in the form of route data or weather data) or from a user of industrial electrical vehicle 300. Input module 360 may include a communications module configured to receive data from the external data source, a user interface configured to receive inputs from a user, and/or another type of communications module. GPS 370 may be configured to receive global positioning data from one or more global positioning satellites and other sources of GPS data. GPS data may provide for the determination of the current position of industrial electrical vehicle 300.

Communication module 380 may be configured to receive external input 392 from one or more external sources 396. Such data may be received via wired and/or wireless communications techniques, such as via an On-Board Diagnostic (OBD) port, via WiFi, via Bluetooth®, and/or via another such technique. Furthermore, communication module 380 may be configured to receive operation instructions 354 from central data system 356 and provide operation report 352 to central data system 356. In certain embodiments, industrial electrical vehicle 300 may be part of a fleet of vehicles associated with an entity (e.g., may be a bus that is part of a fleet of buses). Central data system 356 may be, for example, a command system for controlling the fleet of vehicles. Central data system 356 may, thus, provide operating instructions 354 to communication module 380.

Industrial electrical vehicle 300 may accordingly provide data indicating operating conditions of industrial electrical vehicle 300 (e.g., current position, fuel level, charge level, load level, and/or other such data) to central data system 356 in the form of operation report 352.

System controller 350 may receive data from various systems of industrial electrical vehicle 300 and provide instructions to various systems of industrial electrical vehicle 300. Thus, for example, system controller 350 may receive data from battery 310, input module 360, GPS 370, and communication module 380. From such data, system controller 350 may determine motor instructions 332 for internal combustion motor 390 and/or electric motor 330, power consuming instructions 342 to power consuming devices 340, power generation instructions 322 to range extender 320, and/or provide external data 382 to communication module 380 for communication to external sources (e.g., central data system 356).

Internal combustion motor 390 may be a hydrocarbon fueled motor (e.g., a piston engine) configured to provide direct propulsion (e.g., may power one or more wheels thereof) for industrial electrical vehicle 300. In certain embodiments, industrial electrical vehicle 300 may not include internal combustion motor 390.

Electric motor 330 may be an electric motor configured to provide propulsion for industrial electrical vehicle 300, as described herein. Electric motor 330 may be powered by battery 310. In certain embodiments, range extender 320 may be an internal combustion, fuel cell, or other fueled electricity generator that provides additional electrical charge to battery 310. Range extender 320 may, thus, be operated (based on power generation instructions 322) to generate electrical power that is then stored within battery 310. As such, range extender 320 may be operated to extend the operating range of industrial electrical vehicle 300.

Power consuming devices 340 may be devices of industrial electrical vehicle 300 that consume electrical power. For example, climate control systems, infotainment systems, electric windows, and/or other such systems may be power consuming device 340. In certain embodiments, system controller 350 may provide power consuming instructions 342 to, for example, optimize the range of industrial electrical vehicle 300.

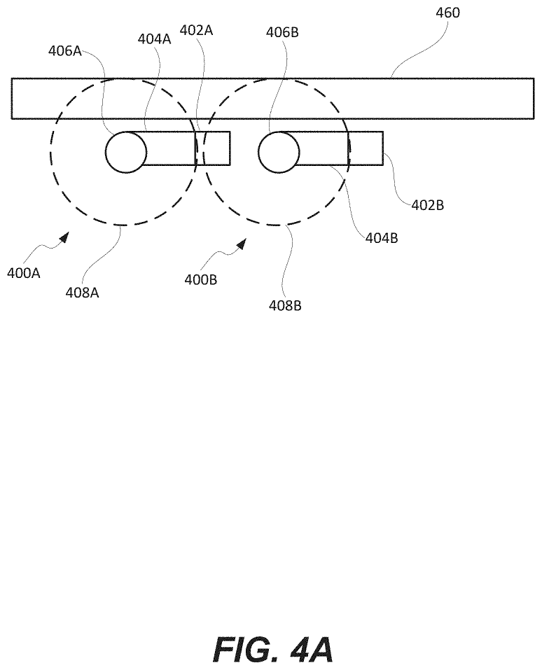

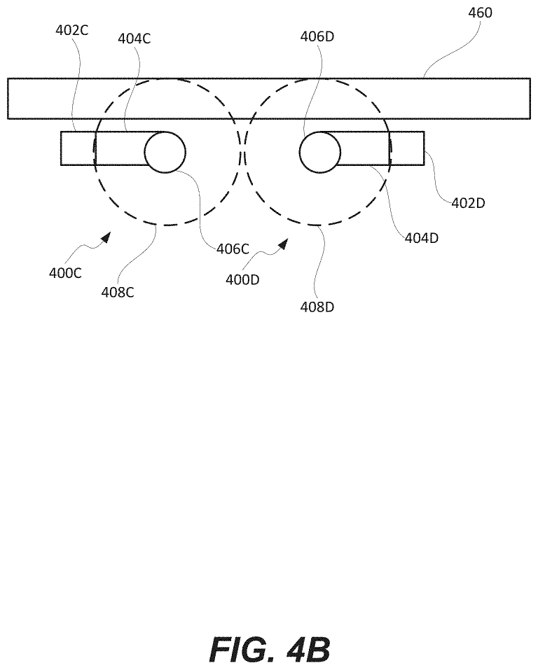

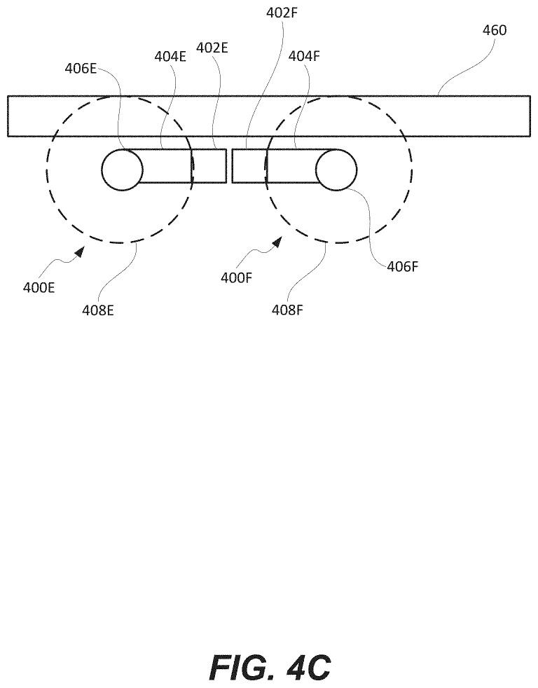

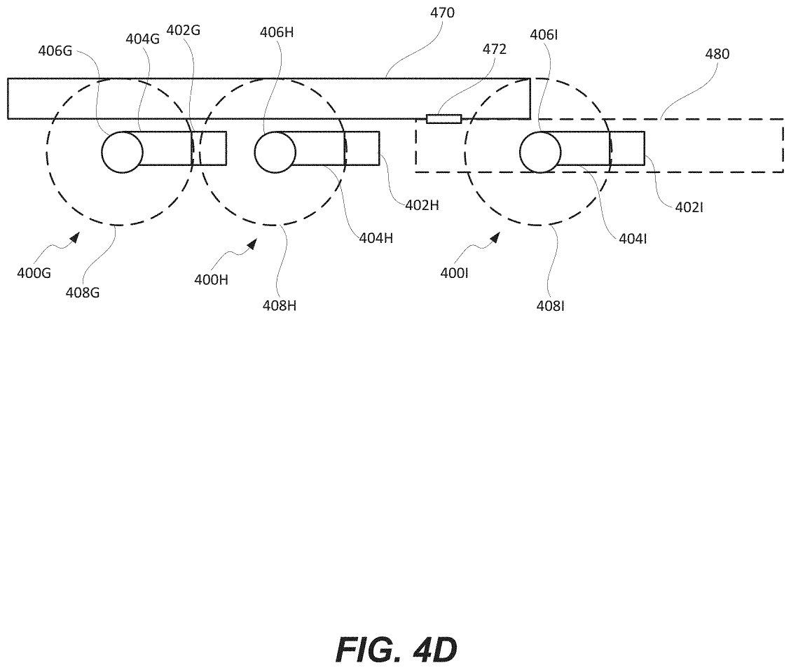

FIGS. 4A-D illustrate representations of powered axle configurations for industrial vehicles, in accordance with some embodiments. FIG. 4A illustrates a portion of a vehicle that includes chassis 460 and a plurality of powered axles 400A and 400B. Powered axle 400A may include electrical motor 402A, transmission 404A, axle 406A, and wheel 408A. Similarly, powered axle 400B may include electrical motor 402B, transmission 404B, axle 406B, and wheel 408B.

The configuration of FIG. 4A disposes powered axles 400A and 400B in the same orientation. As wheels 400A and 400B are typically larger than axles 406A and 406B, respectively, the configuration of FIG. 4A allows for wheels 408A and 408B to be tightly disposed together as electrical motor 402A and/or transmission 404A may be disposed within the dead space between the edge of wheel 400B and axle 406B. Disposing rear wheels tightly together is sometimes desirable in certain industrial applications.

FIG. 4B illustrates a portion of a vehicle that includes chassis 460 and a plurality of powered axles 400C and 400D. Powered axles 400C and 400D may include electrical motors 402C and 402D, respectively, transmissions 404C and 404D, respectively, axles 406C and 406D, respectively, and wheels 408C and 406D, respectively.

The configuration of FIG. 4B orients powered axles 400C and 400D in opposing directions with electrical motor 402C and transmission 404C of powered axle 400C and electrical motor 402D and transmission 404D of powered axle 400D being pointed away from each other. Such a configuration may be oriented so that there is no interference between any of the components of powered axles 400C and 400D (e.g., between electrical motors 402C and 402D) while allowing for rear wheels 408C and 408D to be disposed tightly together. In various embodiments, electrical motors, such as electrical motors 402C and 402D, may be configured to operate with the same amount of power, torque, and motor speed in both forward and reverse directions. As such though the configuration of FIG. 4B with powered axles 400C and 400D being oriented in opposing orientations may require such operating electrical motors 402C and 402D to spin in opposite directions, such a requirement is acceptable due to the nature of electrical motors 402C and 402D.

FIG. 4C illustrates a portion of a vehicle that includes chassis 460 and a plurality of powered axles 400E and 400F. Powered axles 400E and 400F may include electrical motors 402E and 402F, respectively, transmissions 404E and 404F, respectively, axles 406E and 406F, respectively, and wheels 408E and 406F, respectively.

The configuration of FIG. 4C orients powered axles 400E and 400F in opposing directions with electrical motor 402E and transmission 404E of powered axle 400E being pointed towards electrical motor 402F and transmission 404F of powered axle 400F. Such a configuration may be oriented so that there is no interference between any of the components of powered axles 400E and 400F (e.g., between electrical motors 402E and 402F). As such, this configuration may result in wheels 408E and 408F being disposed with a space between them.

FIG. 4D illustrates a portion of a vehicle that includes chassis 480 with powered axle 4001 and trailer chassis 470 with powered axles 400G and 400H. Powered axles 408G-I each include their own respective electrical motors 402G-I, transmissions 404G-I, axles 406G-I, and wheels 408G-I and may each be configured to provide motive power for the vehicle. Accordingly, the trailer of trailer chassis 470 may be a powered trailer as powered axles 408G and 408H may provide motive power. Chassis 480 may be coupled to trailer chassis 470 via trailer coupling 472. Trailer coupling 472 may be a hitch, fifth wheel, or another coupling suitable for coupling a vehicle to a trailer.

Powered axles 400G and 400H may aid in the maneuvering of the trailer. Thus, for example, due to the configuration described herein, the different axles and opposing wheels of powered axles 400G and 400H may be operated at different transmission and motor speeds due to the transmissions described herein. Such operation may allow for torque vectoring by powered axles 400G and 400H. For example, when navigating a tight turn, the outside wheels of powered axles 400G and/or 400H may be operated to produce greater torque (e.g., due to appropriate selection of gears) or the inside wheels of powered axles 400G and/or 400H may be operated to produce drag (e.g., via regenerative braking), in order to aid in steering of the trailer around the obstacle. In certain such situations, the torque vectoring steering may include aspects additional to simply reducing turning radius and may include, for example, allowing for the trailer to maneuver around obstacles, operating the trailer to combat side wind (e.g., by vectoring torque in a manner that counteracts the yaw produced by side wind), combating surface grades and/or crowns, and/or operation in another manner that would aid in the operation of the trailer. Such techniques may be utilized by all powered axles described herein, including for powered axles that are used in a vehicle (e.g., not trailer) configuration.

In certain such embodiments, powered axles 400G and 400H may be operated to power the trailer when reversing. As reversing a trailer is typically difficult since the unpowered axles of a trailer can result in the trailer turning in unintuitive directions for inexperienced drivers, powered axles 400G and/or 400H may be powered to allow for much more intuitive reversing by providing for torque vectoring based on a determined intended route of the user (e.g., as inputted into a navigation device and/or based on the steering angle provided by the operator).

### Gearbox Example

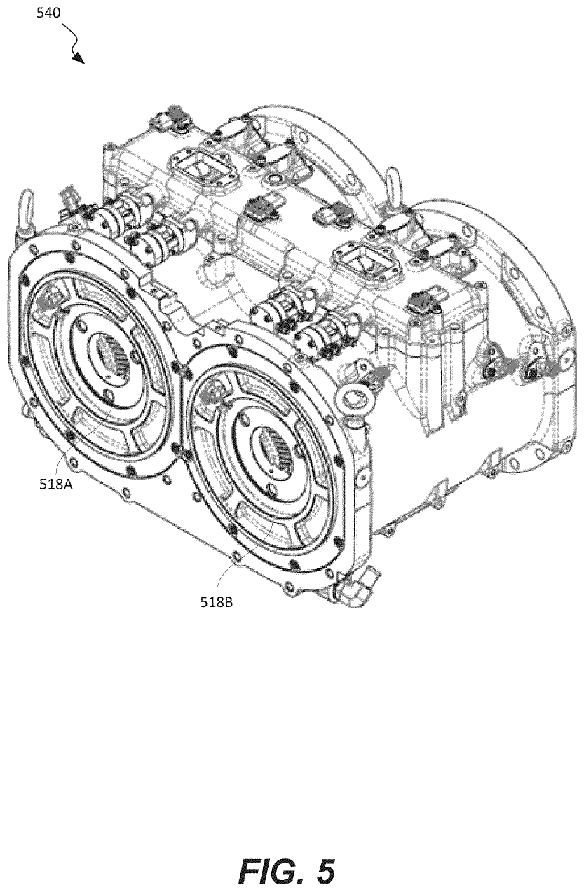

FIG. 5 illustrates a perspective view of an embodiment of a transmission for a powered axle, in accordance with some embodiments. FIG. 5 illustrates transmission 540. Transmission 540 may include one or more casings and a plurality of gearsets. The plurality of gearsets of transmission 540 may be configured to output torque to opposing axles of a vehicle. Thus, the gearsets of transmission 540 may be independent of each other and, accordingly, the opposing axles may be operated in different transmission speeds.

Transmission 540 may be configured to be coupled to a plurality of electrical motors and may include clutches 518A and 518B to control the speed of such coupling. Clutches 518A and 518B may, in certain embodiments, be dog clutches. In certain embodiments, speed sensors may be disposed on clutches 518A and 518B to detect the operating speed of clutches 518A and 518B. Data from the speed sensors may be utilized to operate the electrical motors to, for example, match the speed of the electrical motor to the speed of the gearset to allow for smooth operation of the dog clutches of clutches 518A and 518B.

### Examples of Operating Industrial Electrical Vehicles

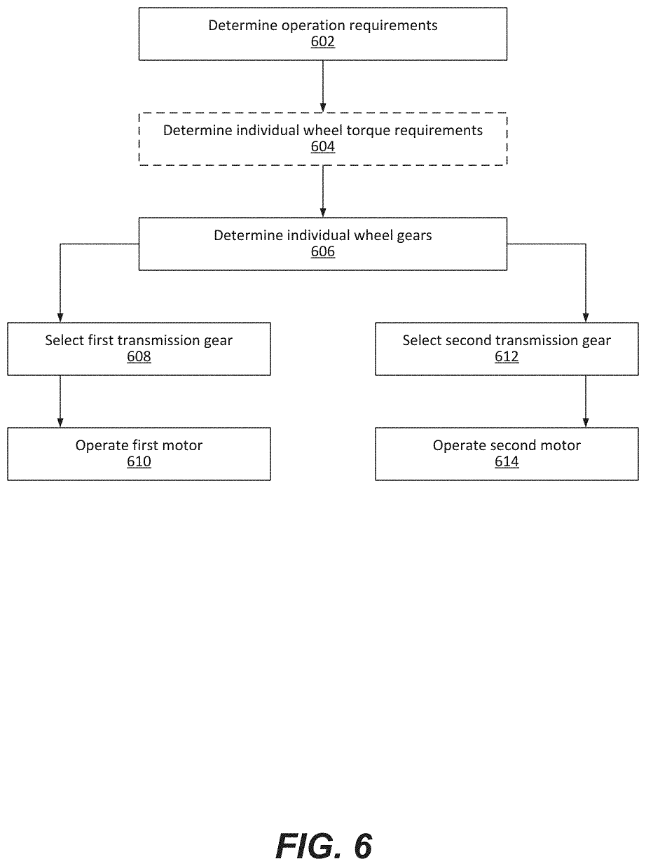

FIG. 6 illustrates a flowchart illustrating a method of operating a powered axle, in accordance with some embodiments. The powered axles of FIG. 6 may be any of the powered axles described herein, including powered axles of industrial vehicles and/or powered trailers. In various embodiments, the powered axles of FIG. 6 may include any combination of electrical motors, transmissions, transaxles, axles, wheels, and/or other such components described herein.

In 602, operation requirements may be determined. The operation requirements may include, for example, the objects for operating the industrial electrical vehicle. Such operation requirements may include, for example, planned route, operational smoothness required, terrain, environmental conditions, surface conditions, and/or other such external conditions. Furthermore, the operations requirements may additionally include vehicle requirements, such as an acceleration or deceleration requirement, an efficiency target, various operation requirements (e.g., whether to regenerate power), nearby obstacles, and/or other such requirements. In certain embodiments, operating conditions, such as the ambient temperature, the current weather, the surface that the vehicle is operating on (e.g., the friction of the surface), obstacles and traffic around the vehicle, the current load of the vehicle, and/or other such operating conditions may also be determined in 602.

Depending on the operation conditions of 602, operation of the industrial electrical vehicle in FIG. 6 may be determined accordingly. For example, in optional 604, the individual wheel torque requirements may be determined. Such wheel torque requirements may be determined based on, for example, any desired torque vectoring of the powered axle, desired consumption for road grades and/or crowns, efficiency targets, and/or other such operations requirements of 602. For example, a system controller of the vehicle may determine the individual wheel torque needed for each wheel of a powered axle in order to keep the vehicle traveling in a straight line and/or to provide the needed torque vectoring. In certain embodiments, the torque curve for each individual and/or the powered axle as a unit may also be determined. Thus, for example, a determination may be made as to the target torque output by powered axle as a unit and/or by all wheels of the vehicle.

In 606, the gear of each individual powered wheel may be determined. In certain embodiments, the gear of each individual powered wheel may be determined based on the wheel torque requirements of 604. As each gear of the transmission may offer different torque multiplication, the wheel torque requirement of each individual wheel, for each powered axle, and/or for the vehicle as a whole may be accordingly determined and the gear selected based on the requirement. In certain embodiments, the wheel torque requirements and the gear selections may be a function of time.

Thus, for example, the torque requirement for a powered axle and/or for a vehicle may be a requirement for continuous torque output. Such a requirement may result in one wheel being shifted before another wheel is shifted and, in certain embodiments, modulating the torque output of the electric motors (e.g., increasing the output of the motor that is not currently being shifted and, thus, outputting torque) to meet the target torque output. In certain embodiments with a plurality of powered axles, the torque output and shifting may be modulated to reduce and/or eliminate yaw from shifting (e.g., for a vehicle with two powered axles, the transmissions associated with one left and one right wheel may first be shifted before the transmissions associated with the remaining left and right wheel may be shifted) while reducing jerk from shifting (e.g., due to the temporary lack of drive while a transmission is shifted). In certain such embodiments, at least a portion of the wheels of such a vehicle may be powered and, thus, consistent acceleration may be provided. Such a technique may be especially advantageous in, for example, loose surfaces such as sand, where temporary loss of power may cause a vehicle to bog down, as such a technique may result in at least a portion of the wheels of a vehicle being powered at all times and, thus, avoiding such bogging down.

In another embodiment, the torque vectoring due to the drive provided by wheels of the powered axle being in different gears may be used to reduce the danger of an industrial electrical vehicle from rolling over. As industrial electrical vehicles typically have high centers of gravity, the additional yaw vectoring produced by the operating one or more wheels on one side of the industrial electrical vehicle in a lower gear as compared to one or more wheels on the other side of the industrial electrical vehicle may provide yaw vectoring that would otherwise be unachievable with conventional techniques, allowing for greater stability in severely off camber terrain and/or in heavy crosswinds.

In a further embodiment, the powered axle may be configured to control wear of a tire. For example, when a vehicle is turning, tire scrub is a significant contributor to tire wear. Such scrub may be due to torque being provided to one or more wheel when cornering and/or speed mismatch between the wheels on opposite ends of an axle when cornering. In various embodiments, depending on the level of current tire wear (e.g., determined by sensors of the vehicle, such as a visual or infrared sensor pointed at the tires that may determine the thickness of the remaining tread of the tire) and/or the acceptable level of tire wear (e.g., provided by an operator of the industrial electrical vehicle), different transmission speeds may be selected. In certain embodiments, the industrial electrical vehicle may provide a plurality of different selectable operating modes. An operator of the industrial electrical vehicle may select one of those modes (which may indicate the amount of tire wear acceptable) and the industrial electrical vehicle may operate accordingly.

Thus, for example, if a high level of wear is acceptable (e.g., if sensors detect that the tires have not worn past a threshold amount), the outside wheel of an industrial electrical vehicle that is turning may utilize a lower gear (e.g., a gear with more torque multiplication) than the inside wheel to provide vectoring. However, if a low level of wear is desired (e.g., if sensors detect that the tires have worn past a threshold amount), then torque vectoring may not be utilized and, additionally or alternatively, the inside wheel may be operated in a lower gear to reduce the speed of the inside wheel in order to reduce tire wear, while still increasing maneuverability.

Based on the wheel torque requirements determined in optional 604 and the gear of each individual powered wheel determined in 606, the transmissions of a powered axle may be operated. Thus, for an embodiment where a powered axle has a plurality of transmissions coupled to a plurality of electrical motors and wheels, the first transmission's gear may be selected in 608 and the second transmission's gear may be selected in 612. Selection of the different gears of the transmission may be independent of each other. Thus, the first transmission may be operated at a first speed while the second transmission may be operated at a second speed. Furthermore, the first transmission and the second transmission may be shifted (e.g., a different gear may be selected) in 606 and the shifting may be performed at different time periods for the first transmission and the second transmission.

The first transmission may be coupled to a first electrical motor and the second transmission may be coupled to a second electrical motor. The first electrical motor may be operated in 610 and the second electrical motor may be operated in 614. Operation of the first electrical motor and the second electrical motor may include operating the electrical motors to produce the desired torque that, for example, results in the desired wheel torque (e.g., as determined by the system controller). Operation of the electrical motors may also include operating the electrical motors to provide for smooth shifting (e.g., stopping or decreasing the amount of torque provided by the electrical motors when the transmission is shifting). In various embodiments, the electrical motors may be operated based on the gear that the respective transmission is in to provide the required wheel torque (e.g., may be configured to provide a specific torque amount based on the torque multiplication of the gear to provide the desired wheel torque).

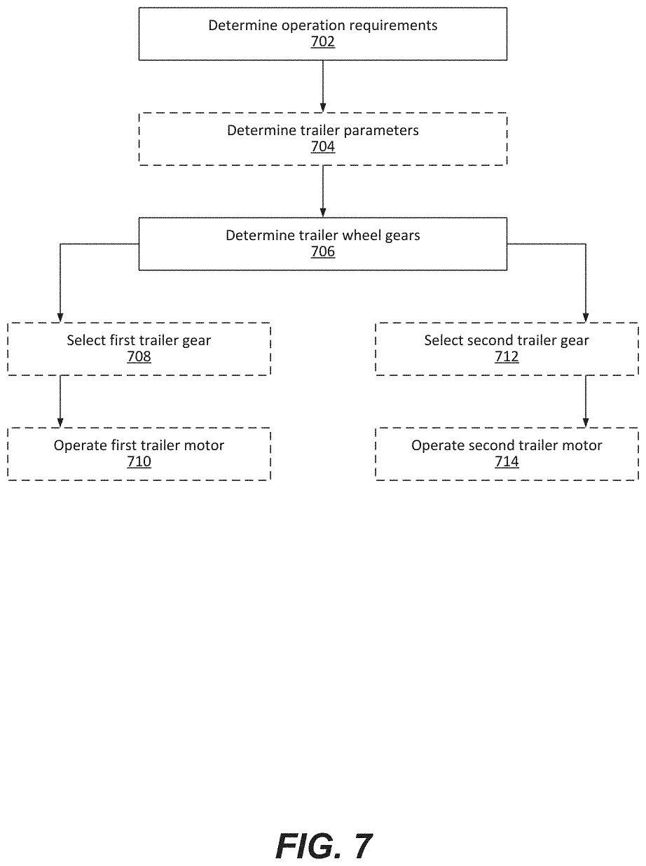

FIG. 7 illustrates a flowchart illustrating a method of operating a trailer with a powered axle, in accordance with some embodiments. Powered axles utilized for trailers may be advantageous. For example, the ability to provide yaw vectoring may be especially advantageous for trailers operated in harsh conditions and/or for road trains that include a plurality of trailers as powered axles within the trailers may provide stability for the road train.

In 702, operation requirements may be determined. Such operation requirements may include the requirements of 602. In optional 704, trailer parameters may be determined. The trailer parameters may include parameters associated with operation of the trailer, such as the dimensions of the trailer and/or the tow vehicle, the steering angle of the tow vehicle, any desired routes by the driver (e.g., routes around obstacles), obstacles around the trailer, the laden weight of the trailer, and/or other such operation requirements. Trailer parameters may allow for determination of how the powered axles are operated to maneuver one or more trailers that are coupled to the vehicle.

In 706, the gear of each individual powered wheel of the trailer may be determined. In certain embodiments, the gear of each individual powered wheel of the trailer may be determined based on the wheel torque requirements determined in 704. Similar to 606, in certain embodiments, the wheel torque requirements and the gear selections may be a function of time.

In certain embodiments, operation of the powered axle and the selection of the determined gear may allow for easier maneuvering of the trailer. In various embodiments, such selected gears may be forward or reverse gears. As such, the selected gear may allow for easier reversing of the trailer, for torque vectoring to keep the trailer on an intended path (e.g., to counter a yaw created by road grade, crown, and/or wind), to maneuver the trailer around obstacles to turn in a tighter radius, and/or to provide other such aid in the operation of the trailer.

Accordingly, the one or more powered axles of the trailer may be operated. Thus, for example, the respective gears of the first transmission and the second transmission (or a single powered axle) may be selected in 708 and 712, respectively. The first and second electrical motors may be respectively operated in 710 and 714. Such operation may be similar to that of selecting transmission speeds and operating electric motors, as described herein (e.g., in 608, 610, 612, and 614 of FIG. 6).

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A vehicle axle comprising:
an axle housing, the axle housing comprising a first output end and a second output end;
a first powertrain, coupled to the axle housing and comprising:
a first electric motor, configured to generate first input torque; and
a first transmission, comprising a first plurality of selectable speeds, each of the first plurality of selectable speeds configured to receive the first input torque and provide mechanical modification of the first input torque to output first output torque to the first output end; and
a second powertrain, coupled to the axle housing and comprising:
a second electric motor, configured to generate second input torque; and
a second transmission, comprising a second plurality of selectable speeds, each of the second plurality of selectable speeds configured to receive the second input torque and provide mechanical modification of the second input torque to output second output torque to the second output end.

2. The vehicle axle of claim 1, wherein the first plurality of selectable speeds of the first transmission and the second plurality of selectable speeds of the second transmission are independently selected.

3. The vehicle axle of claim 1, wherein the axle housing comprises a first end and a second end opposite the first end, wherein the first output end is disposed at the first end, and wherein the second output end is disposed at the second end.

4. The vehicle axle of claim 1, further comprising:
a transmission housing, containing both the first transmission and the second transmission.

5. The vehicle axle of claim 1, further comprising:
a first transmission housing, containing the first transmission; and
a second transmission housing, containing the second transmission.

6. The vehicle axle of claim 1, wherein the first transmission and the second transmission are both oriented in a transaxle configuration relative to the axle housing.

2. A vehicle dynamics control system comprising:
a first powertrain, coupled to a first wheel and comprising:
a first electric motor; and
a first transmission, coupled to the first electric motor and comprising a first plurality of selectable speeds;
a second powertrain, coupled to a second wheel and comprising:
a second electric motor; and
a second transmission, coupled to the second electric motor and comprising a second plurality of selectable speeds; and
a main control processor, configured to perform operations comprising:
receiving vehicle speed and direction data from at least one sensor;
receiving driver data from at least one driver input sensor;
determining, based on the driver data and the vehicle speed and direction data, a first required output torque for the first wheel and a second required output torque for the second wheel;
selecting, based on the first required output torque, a first selected speed from the first plurality of selectable speeds of the first transmission; and
selecting, based on the second required output torque, a second selected speed from the second plurality of selectable speeds of the second transmission.

8. The vehicle dynamics control system of claim 7, wherein the first selected speed includes a first gear ratio and the second selected speed includes a second gear ratio, and wherein the first gear ratio and the second gear ratio are different.

9. The vehicle dynamics control system of claim 8, wherein the direction data indicates angular acceleration.

10. The vehicle dynamics control system of claim 7, wherein the first selected speed includes a first gear ratio and the second selected speed includes a second gear ratio, and wherein the first gear ratio and the second gear ratio are the same.

11. The vehicle dynamics control system of claim 10, wherein the first selected speed is selected during a first time period, and wherein the second selected speed is selected during a second time period different from the first time period.

12. The vehicle dynamics control system of claim 7, wherein the first wheel and the second wheel are disposed on a first axle.

13. The vehicle dynamics control system of claim 7,
a first dog clutch, mechanically coupling the first electric motor and the first transmission; and
a first dog speed sensor, coupled to the first dog clutch and configured to generate dog speed sensor data, wherein the main control processor is further configured to perform operations comprising:
determining, from the dog speed sensor data, a rotational speed of the first dog clutch; and
adjust, based on the rotational speed of the first dog clutch, an output speed of the first electric motor.

14. The vehicle dynamics control system of claim 7, further comprising:
the first wheel; and
the second wheel.

3. An electric vehicle comprising:
a first wheel;
a second wheel;
a first vehicle axle, comprising:
a first gearbox, configured to switch between multiple first gears and comprising a first input shaft and a first output shaft, wherein the first output shaft is mechanically coupled to the first wheel;
a second gearbox, configured to switch between multiple second gears and comprising a second input shaft and a second output shaft, wherein the second output shaft is mechanically coupled to the second wheel;
a first electric motor, mechanically coupled to the first input shaft of the first gearbox; and
a second electric motor, mechanically coupled to the second input shaft of the second gearbox; and
a controller, communicatively coupled to each of the first gearbox, the second gearbox, the first electric motor, and the second electric motor, wherein the controller is configured to instruct the first gearbox to switch between the multiple first gears and, independently, to instruct the second gearbox to switch between the multiple second gears.

16. The electric vehicle of claim 15, further comprising:
a third wheel;
a fourth wheel;
a second vehicle axle, comprising:
a third gearbox, configured to switch between multiple third gears and comprising a third input shaft and a third output shaft, wherein the third output shaft is mechanically coupled to the third wheel;
a fourth gearbox, configured to switch between multiple fourth gears and comprising a fourth input shaft and a fourth output shaft, wherein the fourth output shaft is mechanically coupled to the fourth wheel;
a third electric motor, mechanically coupled to the third input shaft of the third gearbox; and
a fourth electric motor, mechanically coupled to the fourth input shaft of the fourth gearbox.

17. The electric vehicle of claim 16, wherein:
the first vehicle axle further comprises:
a first halfshaft, mechanically coupling the first output shaft to the first wheel; and
a second halfshaft, mechanically coupling the second output shaft to the second wheel; and
the second vehicle axle further comprises:
a third halfshaft, mechanically coupling the third output shaft to the third wheel; and
a fourth halfshaft, mechanically coupling the fourth output shaft to the fourth wheel.

18. The electric vehicle of claim 17, further comprising:
a vehicle frame, comprising a forward end and a rearward end, wherein the first vehicle axle and the second vehicle axle are coupled to the vehicle frame.

19. The electric vehicle of claim 18, wherein the first vehicle axle is disposed forward of the second vehicle axle, wherein the first gearbox is disposed forward of the first halfshaft, and wherein the third gearbox is disposed rearward of the third halfshaft.

20. The electric vehicle of claim 17, further comprising:
a driven vehicle frame, wherein the first vehicle axle is coupled to the vehicle frame; and
a trailer frame, articulatedly coupled to the driven vehicle frame, wherein the second vehicle axle is coupled to the trailer frame.
